(19) United States
(12) Patent Application Publication
(10) Pub. No.: US 2011/0001470 A1
(43) Pub. Date: Jan. 6, 2011

(54) DEVICE FOR MEASURING A POSITION USING THE HALL EFFECT

(75) Inventors: Yann Monteil, Saint Orens (FR); Eric Servel, Roques-sur-Garonne (FR); Marc Vandeginste, Seysses (FR)

Correspondence Address: YOUNG & THOMPSON, 209 Madison Street, Suite 500, Alexandria, VA, 22314, US

(73) Assignee: CONTINENTAL AUTOMOTIVE FRANCE, Toulouse (FR)

(21) Appl. No.: 12/919,125

(22) PCT Filed: Jun. 12, 2009
(86) PCT No.: PCT/EP2009/004246

§ 371 Date: Sep. 16, 2010

(30) Foreign Application Priority Data
Jun. 19, 2008 (FR) 0803431

(51) Int. Cl. G01B 7/30

(52) U.S. Cl. 324/207.2

(57) ABSTRACT

A position measuring device using the Hall effect, includes: a box (30); and a Hall-effect sensor (1), including a cylindrical magnet (10) and a chip (20), in which device: the chip (20) is fastened to the magnet (10); the magnet (10) has a hole (11) right through it, along an axis perpendicular to its bases, and has an outer perimeter (12) and an inner perimeter (13); and the sensor (1) is positioned in the box (30). The device is noteworthy in that:

the inner perimeter (13) is maximized in relation to the mechanical constraints of the magnet (10); and the area of the hole (11) is equal to or greater than the area of the chip (20), so as to obviate the presence of iron filings facing the chip (20).

The present invention relates to a position measuring device using the Hall effect.

Conventionally, such a device comprises a box and a Hall-effect sensor positioned in said box.

The sensor typically comprises a magnet and a chip. The chip is fastened to the magnet, and the magnet, generally of substantially cylindrical shape, has a hole right through it along an axis perpendicular to its bases, so that it has an outer perimeter and an inner perimeter.

Such a measuring device is employed especially in motor vehicle gearboxes, for example to determine the position of the gear selector.

Typically, a gearshift lever is connected to the gearbox via a rod linkage system, so that the movements of the latter result in translation and rotation of a gear selector shaft.

In general, the play and tolerances in the rod linkage system mean that the sensor is preferably placed on the gear selector shaft rather than on the gearshift lever. The “neutral” position of the gearbox corresponds to a generally central position, and the function of the sensor is to determine the position of a target fixed on the gear selector shaft and thus to determine if the box control is in “neutral”.

However, a gearbox comprises gears that are worn away and release iron filings into the oil.

Now, since the sensor has a magnet, this attracts the iron filings present in the oil and these tend to adhere under the sensor (because of the direction of magnetization), thereby disturbing or even preventing the measurement.

To reduce the amount of iron filings present in the oil, it is known to position one or more magnets on the bottom of the gearbox in order to retrieve the iron filings (cf. FR 1 039 119). This thus prevents the filings from becoming attached beneath the sensor. However, such a solution entails an additional cost and does not enable all of the iron filings to be retrieved because of the limited “range” of the magnets thus added.

The object of the present invention is therefore to remedy these drawbacks by providing a solution requiring no additional magnet.

With this objective in mind, the device according to the invention, conforming moreover to the aforementioned preamble, is essentially characterized in that the inner perimeter of the magnet is maximized in relation to the mechanical constraints, and in that the area of the hole in the magnet is equal to or greater than the area of the chip, so as to obviate the presence of iron filings facing the chip.

Thanks to this feature, the iron filings are not attracted so as to face the chip, and consequently they do not disturb the measurement.

In one embodiment, the outer perimeter of the magnet is maximized in relation to the space available in the box.

Thanks to this feature, the iron filings are attracted toward the outside (the external part) of the sensor, i.e. to the sides of the device rather than the underside thereof. By maximizing the outer perimeter it is also possible to obtain a maximum inner parameter while still respecting the mechanical constraints.

In one embodiment, the outer perimeter and/or the inner perimeter have/has at least one flat surface.

In one embodiment, the outer perimeter and/or the inner perimeter are/is cylinders of revolution.

In one embodiment, the ratio of the outer perimeter to the inner perimeter is 2:1.

Preferably, the ratio of the outer perimeter to the inner perimeter is such that the thickness of the magnet ring is mechanically achievable, that is to say it can meet the mechanical constraints of its use. In this case, the minimum thickness of the magnet ring (when the magnet is substantially a hollow cylinder of revolution) is preferably at least 2 mm.

In one embodiment, the external diameter is 10 mm and the internal diameter is 5 mm.

In one embodiment, the device according to the invention further includes a ferromagnetic target, said target being surrounded by a nonferromagnetic element for mechanically sweeping off the iron filings adhering beneath the sensor.

When the ferromagnetic target approaches the sensor, it is magnetized by reaction. Consequently, iron filings can become attached to the target. Thanks to the nonferromagnetic element, the iron filings have less tendency to be attached to the target, especially depending on its thickness.

Furthermore, the nonferromagnetic element has also advantageously a mechanical sweeping effect when there is relative movement between the target and the sensor, enabling the iron filings possibly adhering beneath the sensor to be swept off.

The shape of the nonferromagnetic element is preferably adapted to the relative movement between the target and the sensor, in this case a plane face for a translational movement and a curved face for a rotational movement.

Preferably, the nonferromagnetic element is placed as close as possible to the sensor, i.e. as close as possible to the chip, this being the sensitive surface of the sensor.

In one embodiment, the nonferromagnetic element is made of plastic, in this case a plastic plug fitted onto the target.

In one advantageous embodiment, the chip is offset relative to the zero gauss point of the magnet, in this case placed above said point.

Other features and advantages of the present invention will become more clearly apparent on reading the following description given by way of nonlimiting illustration and with reference to the appended figures in which:

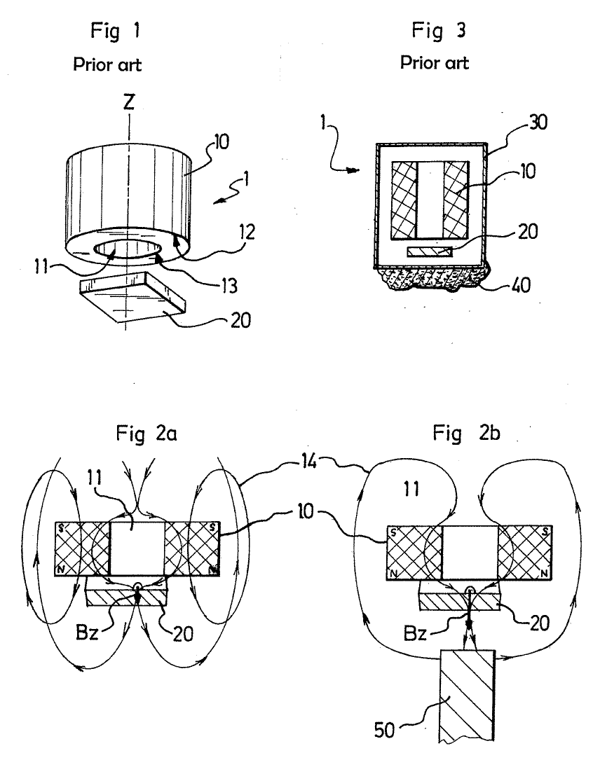

FIG. 1 illustrates a Hall-effect sensor according to the prior art;

FIG. 2a illustrates the operating principle of a Hall-effect measuring device in the absence of a ferromagnetic target;

FIG. 2b illustrates the operating principle of a Hall-effect measuring device in the presence of a ferromagnetic target;

FIG. 3 illustrates, in cross section, iron filings adhering beneath a sensor;

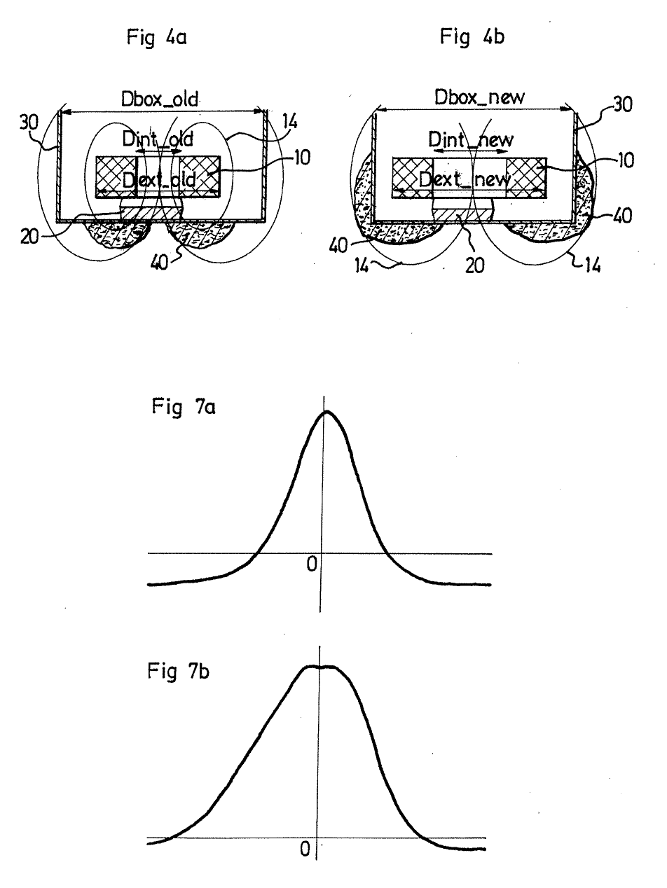

FIG. 4a also illustrates, in cross section, iron filings adhering beneath a sensor according to the prior art;

FIG. 4b illustrates, in cross section, iron filings adhering around a sensor according to the invention;

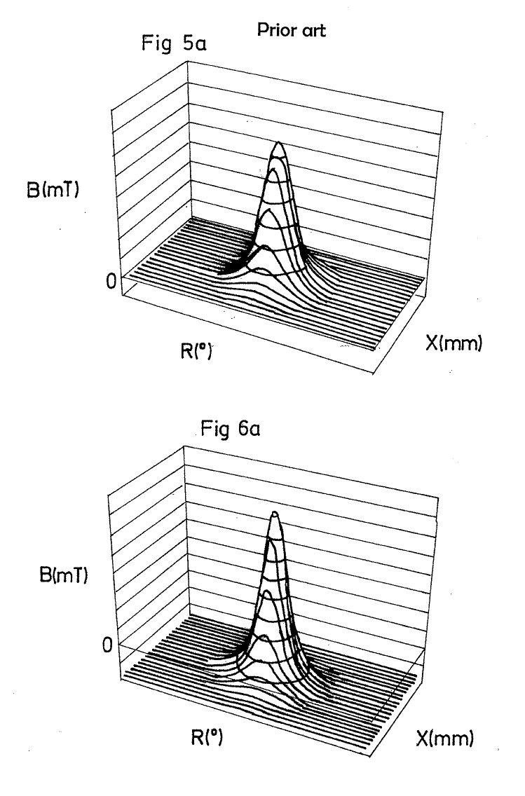

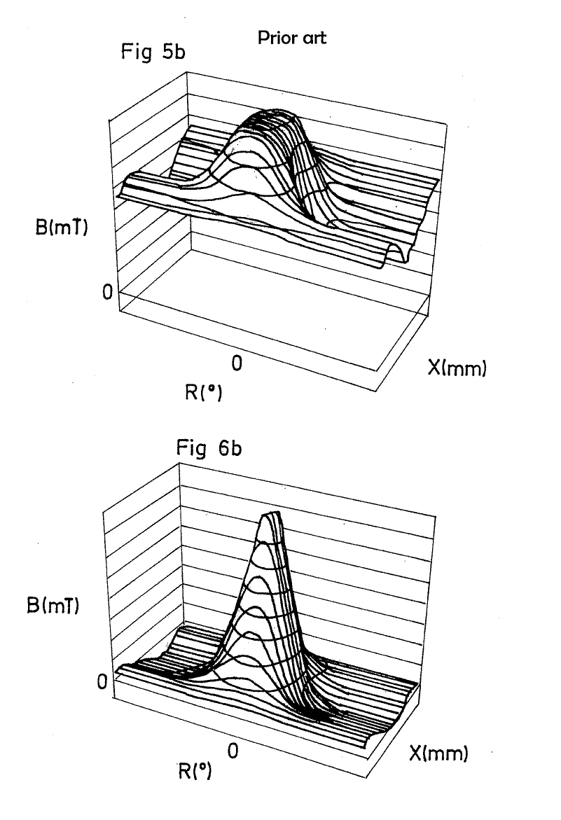

FIG. 5a illustrates the variation in the field of a magnet as a function of the translation and rotation of a target relative to said magnet, according to the prior art in the absence of iron filings;

FIG. 5b illustrates the variation in the field of a magnet as a function of the translation and rotation of a target relative to said magnet, according to the prior art in the presence of iron filings;

FIG. 6a illustrates the variation in the field of a magnet as a function of the translation and rotation of a target relative to said magnet, according to the invention in the absence of iron filings;

FIG. 6b illustrates the variation in the field of a magnet as a function of the translation and rotation of a target relative to said magnet, according to the invention in the presence of iron filings;

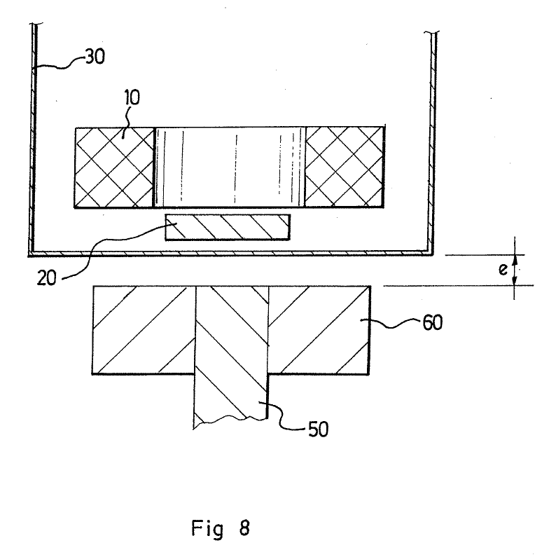

FIG. 7a illustrates the variation in the field of a magnet as a function of the translation of a target relative to said magnet, according to the prior art in the absence of iron filings;

FIG. 7b illustrates the variation in the field of a magnet as a function of the translation of a target relative to said magnet, according to the prior art in the presence of iron filings; and

FIG. 8 illustrates one embodiment of the device according to the invention.

A conventional Hall-effect sensor 1 employed in the invention is illustrated in FIG. 1. It comprises a magnet 10 and a chip 20 fastened to the magnet, said chip being configured so as to measure the magnetic field of the magnet 10, in this case its vertical component Bz, as illustrated in FIG. 2a and FIG. 2b in which the magnet 10 is configured for example with the South face S at the top and the North face N at the bottom.

The chip 20 is preferably positioned facing the hole 11, the hole 11 representing the sensitive zone of the sensor 1.

The magnet 10 has a hole right through it and therefore has an outer perimeter 12 and an inner perimeter 13. Preferably, the hole 11 in the magnet is circular.

In the embodiment illustrated, the magnet has symmetry of revolution about a vertical axis Z, so that its outer perimeter 12 and its inner perimeter 13 are circular and concentric.

FIG. 2a illustrates the operating principle of a Hall-effect measuring device that does not include a ferromagnetic target.

FIG. 2b illustrates the operating principle of a Hall-effect measuring device that includes a ferromagnetic target 50.

By comparing these two figures, the field lines 14 of the magnet are clearly deflected by the presence of the target 50. The component Bz of the magnetic field of the magnet 10 is modified thereby and measured by the chip 20.

As illustrated in FIG. 3, the sensor is positioned in a box 30.

FIG. 3 also illustrates the problem that the invention intends to solve, namely the problem of iron filings 40 adhering beneath the box 30.

Now, as described above, the presence of iron filings may very greatly disturb the field lines, and therefore the measurement.

For this purpose, according to the invention, at least one of the perimeters—the outer perimeter 12 and the inner perimeter 13—is maximized.

As illustrated in FIG. 4a, if the inner perimeter 13 is too small, the iron filings become attached facing the chip 20, in the sensitive zone, and risk disturbing the measurement. However, by maximizing the inner perimeter, that is to say in this case maximizing the diameter, the iron filings are kept away from the sensitive zone.

The influence of the outer perimeter 12 is illustrated in FIG. 4b: increasing this perimeter also shifts the field lines 14 toward the outside of the sensor. Consequently, the iron filings are attracted toward the outside, namely the sides, of the box 30.

Thus, although for economic reasons there is a tendency to reduce the size of a magnet, surprisingly, according to the invention, it is on the contrary recommended to maximize the inner and outer perimeters.

In a preferred embodiment, the inner perimeter 13 is dimensioned so that the hole 11 in the magnet 10 has an area greater than or at least equal to the area of the chip 20.

The thickness of the magnet between its inner and outer perimeters must itself meet the mechanical constraints of using the sensor, in this case at least 2 mm.

The outer perimeter 12 is limited by the size of the box 30 and the constraints for passage of the connections to the chip 20. The shape of the outer and/or inner perimeters may be circular or ovoid. Advantageously, it may also include flat surfaces.

To illustrate the principle of the invention, a cylindrical magnet with a hole through it, the hole also being cylindrical and concentric, may be defined according to the prior art (FIG. 4a).

The cylindrical magnet 10 has an external diameter Dext_old and an internal diameter Dint_old. The magnet is inserted in a box 30, the external dimensions of which are bounded by a diameter Dbox_old.

According to the invention, for a given box of external dimensions limited by a diameter Dbox_new equal to Dbox_old, the dimensions of the magnet 10 are then such that the external diameter Dext_new is greater than the diameter Dext_old and the internal diameter Dint_new is greater than the diameter Dint_old.

A person skilled in the art will readily transpose the above principle to magnet shapes other than cylindrical.

Comparative measurements between an embodiment of the device according to the invention and the prior art have been made and are illustrated in FIGS. 5a, 5b, 6a and 6b.

Each of FIGS. 5a, 5b, 6a and 6b illustrates the measurement B(in mT) of the field of a magnet as a function of the translation X(in mm) and rotation R(in °) of a given target relative to said magnet, for a box of similar dimensions.

FIGS. 5a and 5b illustrate the results of using a device (i.e. a magnet) according to the prior art, in this case a circular magnet of 7 mm external diameter and 3 mm internal diameter, in which FIG. 5a is the response of the sensor in the “normal” configuration (no iron filings) and FIG. 5b is the response of the sensor in the presence of iron filings, in this case 0.2 to 0.3 g of iron filings.

FIGS. 5a and 5b clearly show that the presence of iron filings clips and spreads out the measurement signal, making the sensor ineffective.

FIGS. 6a and 6b illustrate a device, i.e. a magnet, according to the invention, in this case a circular magnet of 10 mm external diameter and 5 mm internal diameter, in which FIG. 6a is the response of the sensor in the “normal” configuration (with no iron filings) and FIG. 6b is the response of the sensor in the presence of iron filings, in this case 2 to 3 g of iron filings, i.e. a response ten times higher than in the case of FIG. 5b.

FIGS. 6a and 6b clearly show that the device according to the invention makes it possible to limit the impact of iron filings being present, since these practically do not modify the response of the sensor.

From the comparison between the prior art (FIG. 5b) and the invention (FIG. 6b), it should be noted that the invention makes it possible to obtain reliable results with an almost ten-fold increase in mass of iron filings.

Moreover, in this kind of device according to the invention, there is what is called the zero Gauss point of the magnet, at which all the components (Bx, By, Bz) of the magnetic field of the magnet are zero.

The advantage of this zero Gauss point is that it is relatively stable in time and relatively independent of the temperature.

For position measurement, as foreseen above, a ferromagnetic part 50, called a target, is generally placed facing the box 30. In operation, the target 50 and the box 30 undergo a relative movement, and the sensor 1 is configured so as to measure the amplitude of this movement, i.e. the relative position between the target and the sensor.

As the target 50 moves, the field of the magnet 10 is deflected, attracted thereby, and there is a large field variation when the target 50 moves facing the magnet.

Moreover, to limit any measurement disturbance, it is known to initially position the chip of the Hall-effect sensor at the zero Gauss point (before the target is introduced, the zero Gauss point being deflected in the presence of the target).

FIG. 7a may correspond for example to a projection of FIG. 5a on a given axis, and corresponds to a device operating without iron filings. Depending on the movement of the target, the measurement signal, corresponding to the intensity of the magnet field, has approximately a Gaussian shape: the signal starts at a relatively constant negative level and then becomes positive, increasing up to a maximum when the target and the sensor are aligned. Beyond the maximum, the signal becomes decreasingly positive, and then negative and relatively constant.

FIG. 7b may correspond for example to a projection of FIG. 5b on a given axis, and corresponds to the device operating with the results illustrated in FIG. 7a when iron filings are present, drawn on the same scale.

The presence of iron filings has the effect of broadening the Gaussian (and therefore disturbing the measurement) and of shifting the signal toward positive values, and consequently raising the maximum and, most particularly, raising the minimum. Now, the closer the minimum becomes to zero, the greater the risk of the sensor in switch mode not switching (i.e. passing through zero).

According to the invention, unlike the prior art, the target 50 is initially positioned advantageously offset relative to the zero Gauss point of the magnet 10, in this case placed a few tenths of a millimeter above said point.

This configuration may especially reduce the level of the magnetic field on the sensitive surface facing the chip 20, thus further reducing the attraction of the iron filings to the sensor 1.

Furthermore, such a configuration makes it possible to obtain a magnetic offset, and therefore a response of the sensor 1 in a zone less impacted by the iron filings. This is particularly advantageous in a switch-type operating mode (defined by the shape of the target 50) of the sensor 1. For such a type of operation of the sensor 1, the output signal of said sensor 1 has only two values, namely a “high” value and a “low” value. Switching from one value to the other takes place for a defined magnetic field, usually (but not necessarily) chosen to be zero. The embodiment according to the invention prevents the offset caused by the presence of iron filings and thus ensures that the sensor 1 operates correctly.

According to another embodiment of the invention, it is even possible to improve the immunity to iron filings of the sensor 1 by placing a nonferromagnetic part 60 around the target 50 (FIG. 8).

Thanks to this configuration, the iron filings 40 do not become attached to the rod 50.

Furthermore, this configuration enables the sensitive surface of the sensor 1 to be cleaned. Cleaning is more effective the smaller the measurement space e is (or the space between the lower face of the box 30 and the upper face of the target 50, usually called the “airgap”). Thus, as the target moves, the nonferromagnetic part 60 pushes the iron filings onto the sides of the sensor 1, far from the chip 20. Each time the target 50 passes in front of the box 30, said target 50 provided with the nonferromagnetic part 60 pushes away the iron filings, in the manner of windshield wipers acting on water droplets. Admittedly, the measurement space e means that a small amount of iron filings may nevertheless remain in position in contact with the box 30, but the amount is reduced. Furthermore, it is entirely conceivable for the nonferromagnetic part 60 to come into direct contact with the box 30 without in any way modifying the airgap between the target 50 and said box 30.

By combining this embodiment with the dimensions of the magnet according to the invention, the performance of the sensor resulting therefrom is greatly superior to that of the prior art.

1. A position measuring device using the Hall effect, comprising:
a box (30); and
a Hall-effect sensor (1), comprising a cylindrical magnet (10) and a chip (20),
in which device:
the chip (20) is fastened to the magnet (10);
the magnet (10) has a hole (11) right through it, along an axis perpendicular to its bases, and has an outer perimeter (12) and an inner perimeter (13); and
the sensor (1) is positioned in said box (30), characterized in that:
the inner perimeter (13) is maximized in relation to the mechanical constraints of the magnet (10); and
the area of the hole (11) is equal to or greater than the area of the chip (20),
so as to obviate the presence of iron filings facing the chip (20).

2. The device as claimed in claim 1, in which the outer perimeter (12) is maximized in relation to the space available in the box (30).

3. The device as claimed in claim 1, in which the outer perimeter (12) and/or the inner perimeter (13) have/has at least one flat surface.

4. The device as claimed in claim 3, in which the ratio of the outer perimeter (12) to the inner perimeter (13) is 2:1.

5. The device as claimed in claim 1, which further includes a ferromagnetic target (50), said target (50) being surrounded by a nonferromagnetic element (60) for mechanically sweeping off the iron filings adhering beneath the sensor.

6. The device as claimed in claim 5, in which the nonferromagnetic element (60) is placed as close as possible to the chip (20).

7. The device as claimed in claim 5, in which the nonferromagnetic element (60) is made of plastic.

8. The device as claimed in claim 5, in which the shape of the nonferromagnetic element (60) is adapted to the relative movement between the target (50) and the Hall-effect sensor (1).

9. The device as claimed in claim 1, in which the chip (20) is offset relative to the zero Gauss point of the magnet (10).

10. The device as claimed in claim 2, in which the outer perimeter (12) and/or the inner perimeter (13) have/has at least one flat surface.

11. The device as claimed in claim 2, in which the ratio of the outer perimeter (12) to the inner perimeter (13) is 2:1.

12. The device as claimed in claim 6 in which the nonferromagnetic element (60) is made of plastic.

13. The device as claimed in claim 6 in which the shape of the nonferromagnetic element (60) is adapted to the relative movement between the target (50) and the Hall-effect sensor (1).

14. The device as claimed in claim 7 in which the shape of the nonferromagnetic element (60) is adapted to the relative movement between the target (50) and the Hall-effect sensor (1).
